(19) United States
(12) Patent Application Publication
(10) Pub. No.: US 2008/0218470 A1
(43) Pub. Date: Sep. 11, 2008

(54) DISPLAY APPARATUS

(75) Inventors: Junji Miyashita, Fujiyoshida-shi (JP); Kenichi Tsuruta, Fujiyoshida-shi (JP); Akira Onikiri, Fujiyoshida-shi (JP)

Correspondence Address: BRINKS HOFER GILSON & LIONE, P.O. BOX 10395, CHICAGO, IL, 60610, US

(73) Assignee: Citizen Electronics Co., Ltd., Fujiyoshida-shi (JP)

(21) Appl. No.: 12/044,784

(22) Filed: Mar. 7, 2008

(30) Foreign Application Priority Data
Mar. 9, 2007 (JP) JP2007-060914
May 18, 2007 (JP) JP2007-133267

(51) Int. Cl. G09G 3/36

(52) U.S. Cl. 345/102

(57) ABSTRACT

A display apparatus includes an image display body having a front surface that rewritably displays image information and a light unit that illuminates the front surface of the image display body. The light unit has a light source and a light-transmitting sheet-shaped first lighting member superimposed over the front surface of the image display body. The first lighting member receives light from the light source and emits the light toward the front surface of the image display body to illuminate the front surface.

### REFERENCE TO THE RELATED APPLICATIONS

This application claims priority under 35 U.S.C. §119 to Japanese Patent application No. JP2007-060914 filed Mar. 9, 2007 and Japanese Patent application No. JP2007-133267 filed May 18, 2007, the entire contents of which are hereby incorporated by reference.

### TECHNICAL FIELD

The present invention relates to display apparatus, e.g. electronic paper displays, which are visible not only in well-lighted places but also at night or in dark places.

### RELATED PRIOR ART

Recently, various display apparatus have been under development. Among them are electronic paper displays that are thin and lightweight and therefore expected to be used as display media replacing paper media, for example, as price labels, electronic books and electronic newspapers. An electronic paper display has advantages of both an electronic display and paper. That is, it can rewritably display image information and keep it displayed even in a power-off state. Because it is a reflective display, the electronic paper display is advantageous in that the contrast ratio does not change and the viewing angle is wide as compared to conventional transmissive liquid crystal display apparatus. For example, Japanese Patent Application Publication No. 2007-41169 proposes a color electronic paper display that uses electrophoretic elements.

The above-described conventional technique, however, still has the following problems to be solved.

The conventional electronic paper display is a non-spontaneous light emission type display medium, and it is reflective. Therefore, the contents displayed thereon are visible by reflection of external light such as sunlight or light from a fluorescent lamp, but the display contents cannot be viewed at night or in a dark place. In addition, because the electronic paper display is a reflective display, it is structurally difficult to adopt a method of passing light therethrough from the back as in the case of a transmissive liquid crystal display apparatus.

In the case of an electronic paper display arranged to be able to display image information on both the front and back surfaces thereof, the information displayed on both the front and back surfaces is made visible in a dark place by providing lighting mechanisms for the front and back surfaces, respectively. With this arrangement, however, the overall thickness increases, and the structure becomes complicated. In addition, the cost increases.

### SUMMARY OF THE INVENTION

The present invention has been made in view of the above-described problems. Accordingly, an object of the present invention is to provide a display apparatus such as an electronic paper display that enables the display contents to be visible even at night or in a dark place and that is manufacturable at low cost.

The present invention provides a display apparatus including an image display body having a front surface that rewritably displays image information and a light unit that illuminates the front surface of the image display body. The light unit has a light source and a light-transmitting sheet-shaped first lighting member superimposed over the front surface of the image display body. The first lighting member receives light from the light source, emits the light toward the front surface of the image display body, and illuminates the front surface.

In the above-described display apparatus, the light unit that illuminates the front surface of the image display body has a first lighting member that can transmit light entering through both front and back surfaces thereof. Further, the first lighting member guides light entering through an end surface thereof while scattering it and emits the light toward at least the front surface of the image display body. Thus, light from the light source is guided while being scattered to illuminate the image display body from the front surface side thereof, and reflected light from the image display body is transmitted through the first lighting member from the back toward the front thereof, thereby enabling the contents displayed on the image display body to be viewed even in a dark place. In addition, the light unit can be simply constructed with the light source, which may be an LED light source, and the first lighting member, which may be formed from a resin sheet. Therefore, the display apparatus can be manufactured at a very low cost.

The display apparatus of the present invention may be arranged as follows. The first lighting member has an edge surface that receives light, and the light unit has an elongated light guide member disposed to extend along the edge surface. The elongated light guide member receives light from the light source through one end thereof, guides the light toward the other end thereof and emits the light toward the edge surface of the first lighting member and the first lighting member is configured to receive the light through the edge surface thereof.

The above-described display apparatus has an elongated light guide member that can supply light from the light source into the first lighting member. Accordingly, light from the light source is guided through the elongated light guide member, supplied into the first lighting member from the elongated light guide member and emitted from the first lighting member toward the front and back surface of the image display body to illuminate the front and back surface, and reflected light from the image display body is transmitted through the first lighting member, thereby enabling the contents displayed on the front and back surface of the image display body to be viewed even in a dark place.

The display apparatus of the present invention may be arranged as follows. The image display body has a back surface that rewritably displays image information. The light unit has a light-transmitting sheet-shaped second lighting member superimposed over the back surface of the image display body. The second lighting member receives light from the light source and emits the light toward the front surface of the image display body to illuminate the back surface.

The display apparatus of the present invention may be arranged as follows. The first and second lighting members have edge surfaces that receive light, respectively. The light unit has an elongated light guide member disposed to extend along the edge surfaces of the first and second lighting members. The elongated light guide member receives light from the light source through one end thereof, guides the light toward the other end thereof and emits the light toward the edge surfaces of the first and second lighting members.

In the display apparatus of the present invention, the first and second lighting members may be lenticular lens films, respectively. A lenticular lens has a plurality of half-cylindrical lens elements linearly extending in a direction perpendicular to a light propagation direction. The lenticular lens can guide light in the light propagation direction, and while doing so, it can also guide light in a direction different from the light propagation direction, e.g. a direction perpendicularly intersecting the light propagation direction. Thus, each lighting member can efficiently guide light entering through the edge surface thereof in the light propagation direction, and while doing so, it can also efficiently guide the light toward a surface of the image display body. Accordingly, it is possible to illuminate uniformly the entire area of the image display body. In addition, the lighting member can efficiently transmit external light entering through the front surface thereof, such as light from a fluorescent lamp or sunlight, and light reflected from the image display body.

In the display apparatus of the present invention, the image display body may be an electronic paper body capable of rewritably displaying image information on both front and back surfaces thereof and keeping it displayed in a power-off state. That is, because the display apparatus uses an electronic paper body as the image display body, an electronic paper, which is a non-spontaneous light emission type display medium, can be utilized not only in light places but also in dark places. In addition, because both the front and back surfaces of the electronic paper body are illuminated with a single light unit, the number of components can be reduced, and it is possible to simplify the overall structure of the apparatus and to reduce the thickness and cost thereof. Further, the light unit can be simply constructed with the light source, which may be an LED light source, and the first and second lighting members, which may be formed from resin sheets. Therefore, the display apparatus can be manufactured at a very low cost.

The present invention offers the following advantageous effects. The display apparatus of the present invention enables the display contents to be visible even in a dark place and can be manufactured at low cost. Accordingly, the display apparatus, e.g. electronic paper display, can be utilized not only in light places but also in dark places. Thus, it is possible to expand considerably the range of usable environments such as places and the range of equipment to which electronic paper displays are applicable.

### BRIEF DESCRIPTION OF THE DRAWINGS

FIG. 1 shows a fragmentary sectional view showing a first embodiment of the display apparatus according to the present invention.

FIG. 2 shows a side view of a display apparatus in the first embodiment.

FIGS. 3a and 3b show plan and side views, respectively, showing an electronic paper body in the first embodiment.

FIGS. 4a and 4b show plan and side views, respectively, showing a front light unit in the first embodiment.

FIGS. 5a and 5b show plan and side views, respectively, showing a front light unit in a second embodiment of the display apparatus according to the present invention.

FIG. 6 shows a fragmentary sectional view showing a third embodiment of the display apparatus according to the present invention.

FIG. 7 shows a side view of a display apparatus in the third embodiment.

FIGS. 8a and 8b show plan and side views, respectively, showing an electronic paper body in the third embodiment.

FIG. 9 shows a plan view showing a light unit in the third embodiment.

FIGS. 10a, 10b and 10c show plan, side and X-X sectional views, respectively, showing a light unit in a fourth embodiment of the display apparatus according to the present invention.

### DETAILED DESCRIPTION OF THE INVENTION

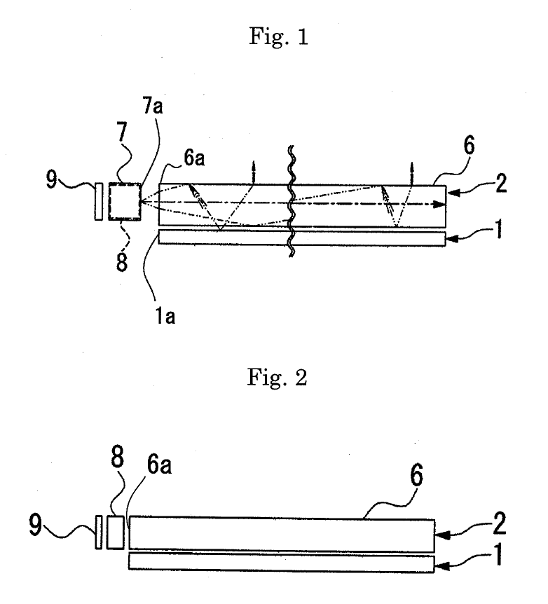

A first embodiment of the display apparatus according to the present invention will be explained below with reference to FIGS. 1 to 4b. It should be noted that the scale of the figures used in the following explanation is properly changed to show each member in a recognizable size.

The display apparatus in this embodiment is, as shown in FIGS. 1 and 2, an electronic paper display having an electronic paper body 1 as an image display body having a surface capable of rewritably displaying image information and keeping it displayed in a power-off state. The electronic paper display further has a front light unit 2 as a light unit that illuminates a front surface of the electronic paper body 1.

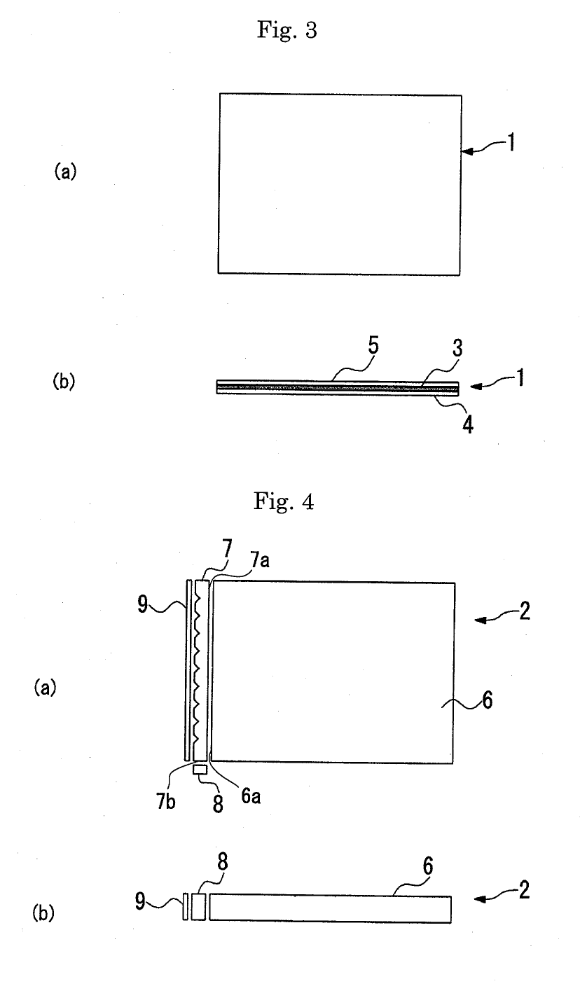

The electronic paper body 1 in this embodiment is, as shown in FIGS. 3a and 3b, a laminated film having a sandwich structure comprising an ink layer 3, a driver layer 4 disposed on the back of the ink layer 3, and a light-transmitting film 5 disposed on the front of the ink layer 3.

The ink layer 3 is a layer of microcapsules or electrically charged beads. The driver layer 4 comprises active-matrix TFTs (thin film transistors) and has the function of performing display control of the electronic paper display.

The electronic paper body 1 may, for example, be an electrophoretic electronic paper using microcapsules, or an electronic paper using electrically charged black and white beads. In the case of an electrophoretic electronic paper, for example, a blue liquid and white electrically charged particles, e.g. titanium oxide particles, are encapsulated in microcapsules, and the driver layer 4, which is an electrode layer, is disposed at the back of the ink layer 3 comprising the microcapsules. In the electrophoretic electronic paper, when the white particles are at front of the microcapsules, a white display appears. When the charged particles are attracted to the back of the microcapsules by applying a minus voltage to the electrode layer, the blue liquid is present at the front of the microcapsules, resulting in a black display. In this way, black and white display control is performed.

The front light unit 2 has a light source 8 and a first lighting member 6 with light-transmitting properties that is superimposed over the front surface of the electronic paper body 1. The first lighting member 6 can transmit light entering through the front and back surfaces thereof and has an edge surface 6a that receives light from the light source 8. The edge surface 6a is aligned with an edge surface 1a of the electronic paper body 1 along an imaginary vertical line. The first lighting member 6 receives light entering through the edge surface 6a and guides it therethrough. While doing so, the first lighting member 6 reflects and refracts the light in a direction perpendicular to the light propagation direction, thereby allowing the light to exit toward the front surface of the electronic paper body 1. An elongated light guide member 7 is disposed near the edge surface 6a of the first lighting member 6 to extend along the edge surface 6a. The light source 8 is disposed adjacent to one end of the elongated light guide member 7 to supply light to the first lighting member 6 through the elongated light guide member 7. A reflector 9 is disposed at the back of the elongated light guide member 7 (i.e. a side of the elongated light guide member 7 opposite to the side thereof facing the edge surface 6a of the first lighting member 6).

It should be noted that the light source 8 may be disposed in close proximity to the edge surface 6a of the first lighting member 6 so that light from the light source 8 directly enters the first lighting member 6 through the edge surface 6a.

The first lighting member 6 is in a sheet-shaped member. The term “sheet-shaped member” as used in this specification includes a film-shaped member and a plate-shaped member. Accordingly, the edge surface 6a of the first lighting member 6 having such a shape means an end surface that connects between the front and back surfaces of a sheet-shaped member. The fact that the first lighting member 6 is in a sheet form enables a reduction in the overall thickness of the display apparatus in cooperation with the fact that the electronic paper body 1 is thin. In addition, the first lighting member 6 is readily bendable, which enables the display apparatus to be usable in an application where the electronic paper body 1 may be bent.

As the first lighting member 6, a diffusing film having the function of reflecting and refracting light with isotropic scattering is particularly preferably used. It is preferable that the first lighting member 6 should have been set to a predetermined haze value and a predetermined thickness. Preferably, the predetermined haze value is about from 0.1 to 2.0, and the predetermined thickness is about from 0.02 μm to 0.30 μm. It should be noted that the haze value is a measure of transparency or the degree of haze and expressed in a percentage of the scattered light forward transmittance divided by the total light transmittance.

Examples of materials usable to form the first lighting member 6 are a single-layer film of PC (polycarbonate), PMMA (polymethylmethacrylate, i.e. acrylic resin), COP (cycloolefin polymer) or PET (polyethylene terephthalate) , a double-layer film of any one of these resins and a UV (ultraviolet) curing resin, and an elastomer film such as silicone film.

The elongated light guide member 7 is, as shown in FIG. 4a, a bar-shaped member, which is preferably formed from a transparent polycarbonate, acrylic or other similar resin material. The elongated light guide member 7 receives light from the light source 8 disposed in close proximity to one end 7b in the longitudinal direction thereof and guides the light toward the other end thereof. While doing so, the elongated light guide member 7 allows the light to emit from an end surface 7a toward the edge surface 6a of the first lighting member 6 by reflection, refraction and diffusion. It should be noted that the elongated light guide member 7 has a plurality of inclined surfaces or the like formed on a back surface thereof (i.e. a surface thereof closer to the reflector 9) to reflect the light received and guided therein toward the edge surface 6a of the first lighting member 6 (see FIG. 4a).

The reflector 9 is formed by using a metal sheet, film or foil having a light-reflecting function. The reflector 9 has the function of reflecting light exiting through the back surface of the elongated light guide member 7 back thereinto.

The light source 8 is a white LED (light-emitting diode) light source disposed in close proximity to one end 7b in the longitudinal direction of the elongated light guide member 7. The white LED light source is, for example, formed by sealing a semiconductor light-emitting element on a substrate with a resin material. The semiconductor light-emitting element is, for example, a blue (wavelength λ: 470 to 490 nm) LED element or an ultraviolet (wavelength λ: less than 470 nm) LED element, which is formed, for example, by stacking a plurality of semiconductor layers of a gallium nitride compound semiconductor (e.g. InGaN compound semiconductor) on an insulating substrate, e.g. a sapphire substrate.

The resin material used to seal the semiconductor light-emitting element is preferably prepared by adding, for example, aYAG fluorescent substance into a silicone resin as a main component. The YAG fluorescent substance converts blue or ultraviolet light from the semiconductor light-emitting element into yellow light, and white light is produced by color mixing effect. It should be noted that various LEDs in addition to those described above can be employed as the white LED light source.

In the display apparatus of this embodiment arranged as stated above, illuminating light from the light source 8 can be applied to the electronic paper body 1 from the front side thereof efficiently and uniformly, and reflected light from the electronic paper body 1 is transmitted through the first lighting member 6 from the back toward the front thereof, thereby enabling the contents displayed on the image display body (i.e. the electronic paper body 1) to be viewed even in a dark place.

In addition, because the front light unit 2 can be simply constructed with the light source 8 of LED and the first lighting member 6 formed from a resin sheet, etc., the electronic paper display can be manufactured at a very low cost.

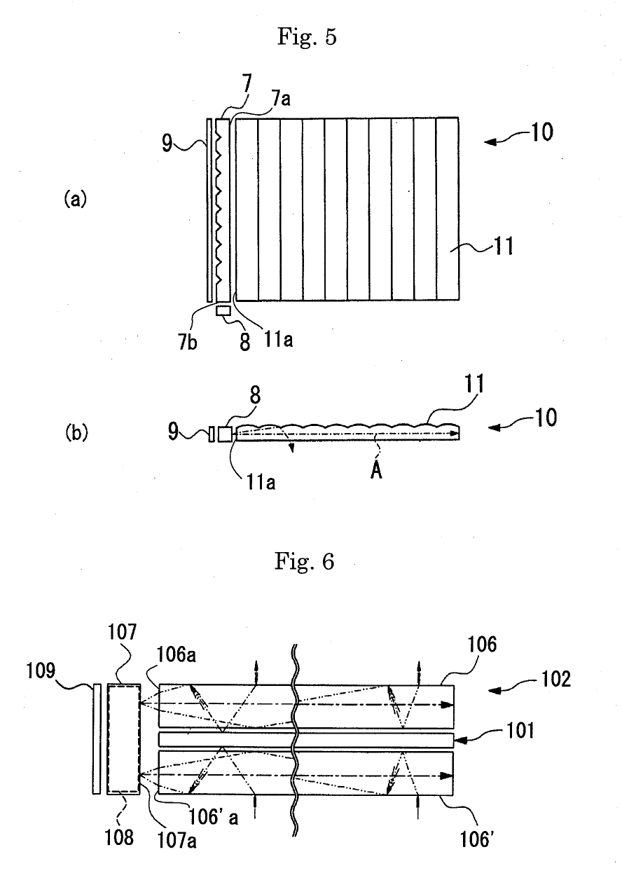

Next, a second embodiment of the electronic paper display according to the present invention will be explained below with reference to FIGS. 5a and 5b. It should be noted that in the following description of the second embodiment the same constituent elements as those of the foregoing first embodiment are denoted by the same reference numerals as used in the first embodiment, and redundant explanation is omitted.

The second embodiment differs from the first embodiment as follows. In the first embodiment, the first lighting member 6 is a diffusing film or the like that reflects and refracts light isotropically. In the electronic paper display of the second embodiment, as shown in FIGS. 5a and 5b, a first lighting member 11 of a front light unit 10 is a lenticular lens having the properties of guiding light entering through an edge surface 11 a in a light propagation direction A and of reflecting and refracting the light in a direction perpendicular to the light propagation direction A.

The lenticular lens is in a film form and has on a surface thereof a plurality of half-cylindrical lens elements linearly extending in a direction perpendicular to the light propagation direction A (i.e. a direction perpendicular to the extension direction of the elongated light guide member 7 and parallel to the lenticular lens). The lenticular lens having the half-cylindrical lens elements can guide light in the light propagation direction A therein, and while doing so, it can reflect and refract a necessary amount of light to guide it in a direction intersecting the light propagation direction A at an angle of 90°. Thus, light can be guided throughout the first lighting member 11, and uniform light can be efficiently emitted toward the electronic paper body 1 at the back of the first lighting member 11.

Thus, in the second embodiment, a lenticular lens is used as the first lighting member 11. Therefore, the first lighting member 11 can efficiently guide light entering through the edge surface 11a, and while doing so, it can reflect and refract the light to illuminate uniformly the entire area of the electronic paper body 1. In addition, the first lighting member 11 can efficiently transmit external light entering through the front surface, such as light from a fluorescent lamp or sunlight, and light reflected from the electronic paper body 1. Particularly, the lenticular lens can efficiently emit uniform light toward the electronic paper body 1 by a plurality of half-cylindrical lens elements.

Next, a third embodiment of the display apparatus according to the present invention will be explained with reference to FIGS. 6 to 9. It should be noted that the scale of the figures used in the following explanation is properly changed to show each member in a recognizable size. In the following explanation of the third embodiment, constituent elements are denoted by reference numerals in the order of 100, and the same constituent elements as those of the above-described embodiments are denoted by reference numerals that are the same in the first digit as used in the foregoing embodiments.

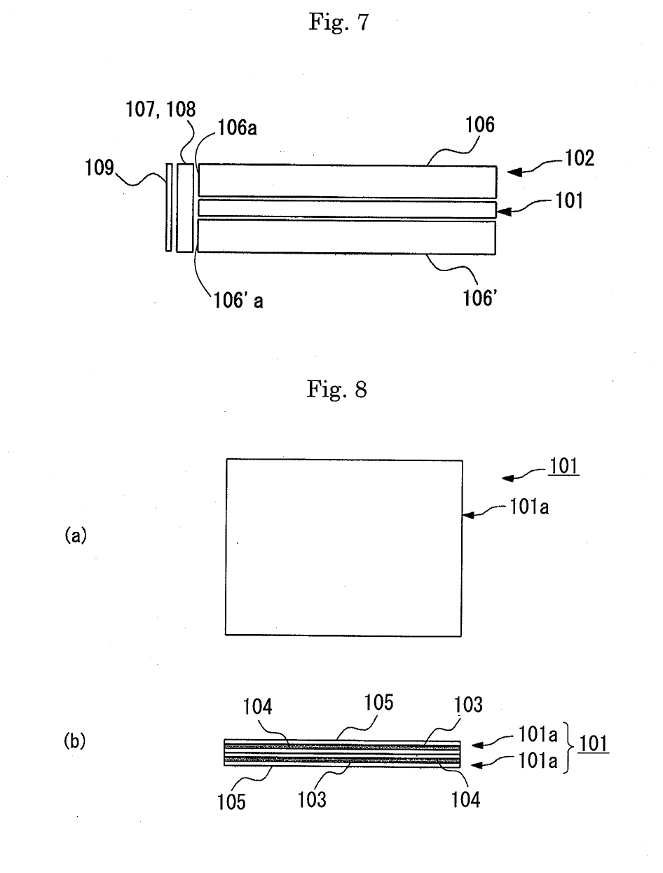

The display apparatus in this embodiment is, as shown in FIGS. 6 and 7, an electronic paper display having an electronic paper body 101 as an image display body whose front and back surfaces are capable of rewritably displaying image information and keeping it displayed in a power-off state. The electronic paper display further has a light unit 102 that illuminates the front and back surfaces of the electronic paper body 101.

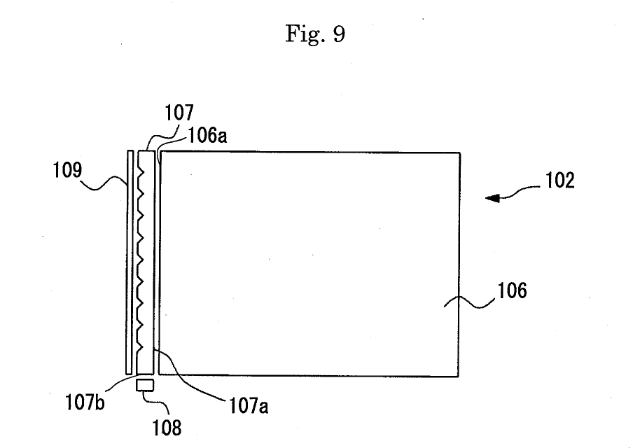

The electronic paper body 101 comprises, as shown in FIGS. 8a, 8b and 9, a pair of electronic paper body members 101a that are superimposed on one another such that their respective back surfaces face each other, thereby allowing the front and back surfaces of the electronic paper body 101 to form display surfaces capable of displaying image information, respectively. The electronic paper body members 101a constituting the electronic paper body 101 are each a laminated film having a sandwich structure comprising an ink layer 103, a driver layer 104 disposed on the back (rear) of the ink layer 103, and a transparent film 105 disposed on the front (display surface side) of the ink layer 103.

Materials used to form the ink layer 103 and the driver layer 104 and the functions thereof are the same as in the foregoing embodiments.

The electronic paper body members 101a of the electronic paper body 101 each comprise an electronic paper similar to that used to constitute the electronic paper body 1 in the foregoing embodiments.

The light unit 102 includes a first lighting member 106, a second lighting member 106′, an elongated light guide member 107, a light source 108, and a reflector 109. The first and second lighting members 106 and 106′ are disposed at front and back sides, respectively, of the electronic paper body 101. The elongated light guide member 107 is disposed near one end of the pair of lighting members 106 and 106′ to guide light entering therein and to emit the light from an end surface 107a facing edge surfaces 106a and 106′a of the first and second lighting members 106 and 106′ so that the light enters the two lighting members 106 and 106′. The light source 108 is disposed in close proximity to one end 107b of the elongated light guide member 107 so that light emitted therefrom enters the elongated light guide member 107. The reflector 109 is disposed along the back of the elongated light guide member 107 (i.e. a side of the elongated light guide member 107 opposite to the side thereof facing the edge surfaces 106a of the first and second lighting members 106).

Materials used to form the first and second lighting members 106 and 106′, the elongated light guide member 107, the light source 108 and the reflector 109 and so forth are the same as those of the first lighting member 6, the elongated light guide member 7, the light source 8 and the reflector 9 in the foregoing embodiments.

Thus, the display apparatus in this embodiment has the first and second lighting members 106 and 106′ disposed at the front and back sides, respectively, of the electronic paper body 101 and the elongated light guide member 107 that supplies light from the light source 108 into the two lighting members 106 and 106′. Therefore, it is possible to illuminate both the front and back surfaces of the electronic paper body 101. That is, light from the light source 108 is guided through the elongated light guide member 107 and supplied therefrom into the first and second lighting members 106 and 106′ disposed at the front and back sides, respectively, of the electronic paper body 101. Then, the light is emitted from the first and second lighting members 106 and 106′ to illuminate the front and back surfaces of the electronic paper body 101, and reflected light from the electronic paper body 1 is transmitted through the first and second lighting members 106 and 106′, thereby enabling the contents displayed on the front and back surfaces of the electronic paper body 101 to be viewed even in a dark place.

In addition, because both the front and back surfaces of the electronic paper body 101 are illuminated with a single light unit 102, the number of components can be reduced, and it is possible to simplify the overall structure of the apparatus and to reduce the thickness and cost thereof. That is, it is unnecessary to provide a combination of a light source 108 and an elongated light guide member 107 for each of the front and back surfaces of the electronic paper body 101. A single combination of a light source 108 and an elongated light guide member 107 can illuminate both the front and back surfaces of the electronic paper body 101.

Further, because the light unit 102 can be simply constructed with the light source 108 of LED and the first and second lighting members 106 and 106′ formed from resin sheets, the electronic paper display can be manufactured at a very low cost.

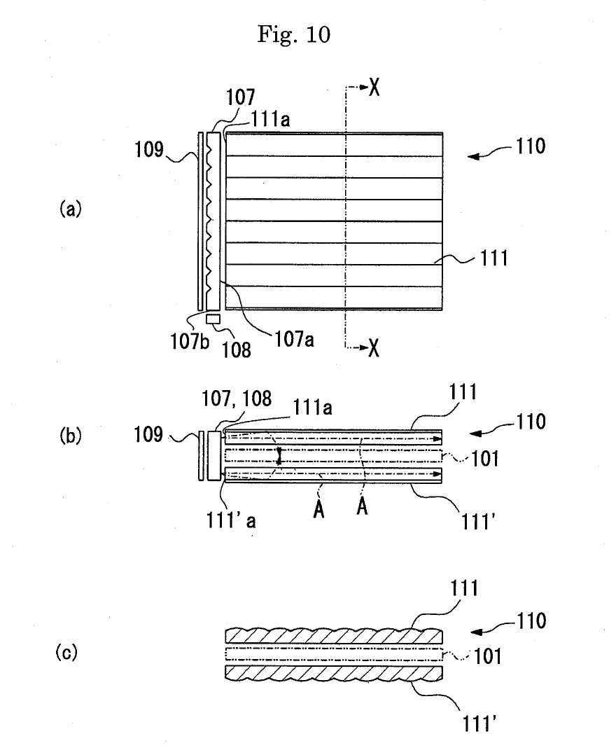

Next, a fourth embodiment of the display apparatus according to the present invention will be explained below with reference to FIGS. 10a, 10b and 10c. It should be noted that in the following description of the fourth embodiment the same constituent elements as those of the foregoing third embodiment are denoted by the same reference numerals as used in the third embodiment, and redundant explanation is omitted.

The fourth embodiment differs from the third embodiment as follows. In the third embodiment, the first and second lighting members 106 and 106′ are diffusing films or the like that reflect and refract light isotropically. In the display apparatus of the fourth embodiment, as shown in FIGS. 10a, 10b and 10c, first and second lighting members 111 and 111′ of a light unit 110 are lenticular lenses having the properties of guiding light entering through edge surfaces 111a and 111′a in a light propagation direction A and of reflecting and refracting the light in a direction perpendicular to the light propagation direction A.

The lenticular lenses used in the fourth embodiment are in film form, and the same lenticular lens film as in the second embodiment is used as each lenticular lens.

Thus, in the fourth embodiment, lenticular lenses are used as the first and second lighting members 111 and 111′. Therefore, the lighting members 111 and 111′ can efficiently guide light entering through the edge surfaces 111a and 111′a, and while doing so, they can reflect and refract the light to illuminate uniformly the entire area of the electronic paper body 101. In addition, each lighting member can efficiently transmit external light entering through the front surface, such as light from a fluorescent lamp or sunlight, and light reflected from the electronic paper body 1. Particularly, each lenticular lens can efficiently emit uniform light toward the electronic paper body 101 by a plurality of half-cylindrical lens elements.

It should be noted that the present invention is not necessarily limited to the foregoing embodiments but can be modified in a variety of ways without departing from the scope of the present invention.

For example, although it is preferable that the present invention be applied to electronic paper displays that are structurally difficult to form into a transmissive type, the present invention may be applied to other display apparatus using a non-spontaneous light emission type image display body such as a liquid crystal display panel. In such a case, a pair of liquid crystal display panels are superimposed on one another such that their respective back surfaces face each other, thereby forming an image display body, and first and second lighting members are disposed at the front and back sides, respectively, of the image display body so as to sandwich the two liquid crystal display panels therebetween. Thus, a liquid crystal display apparatus capable of displaying image information on both the front and back surfaces thereof can be obtained.

1. A display apparatus comprising:
an image display body having a front surface that rewritably displays image information; and
a light unit that illuminates the front surface of the image display body;
the light unit having a light source and a light-transmitting sheet-shaped first lighting member superimposed over the front surface of the image display body, the first lighting member configured to receive light from the light source, to emit the light toward the front surface of the image display body, and to illuminate the front surface.

2. The display apparatus of claim 1, wherein the image display body has a back surface that rewritably displays image information;
the light unit having a light-transmitting sheet-shaped second lighting member superimposed over the back surface of the image display body, the second lighting member configured to receive light from the light source, to emit the light toward the back surface of the image display body, and to illuminate the back surface.

3. The display apparatus of claim 1, wherein the first lighting member has an edge surface that receives light emitted from the light source;
the light unit having an elongated light guide member disposed to extend along the edge surface of the first lighting member;
the elongated light guide member configured to receive light from the light source through one end thereof, to guide the light toward the other end thereof and to emit the light toward the edge surface of the first lighting member;
the first lighting member configured to receive the light through the edge surface thereof.

4. The display apparatus of claim 2, wherein the first lighting member and the second lighting member have edge surfaces that receive light, respectively;
the light unit having an elongated light guide member disposed to extend along the edge surfaces of the first lighting member and the second lighting member;
the elongated light guide member configured to receive light from the light source through one end thereof, to guide the light toward an other end thereof and to emit the light toward the edge surfaces of the first lighting member and the second lighting member.

5. The display apparatus of claim 1, wherein the first lighting member is a lenticular lens film.

6. The display apparatus of claim 2, wherein the second lighting member is a lenticular lens film.

7. The display apparatus of claim 1, wherein the image display body is an electronic paper body capable of keeping image information displayed on a front surface thereof in a power-off state.

8. The display apparatus of claim 2, wherein the image display body is an electronic paper body capable of keeping image information displayed on both front and back surfaces thereof in a power-off state.
